(19) United States
(12) Patent Application Publication
(10) Pub. No.: US 2024/0192424 A1
(43) Pub. Date: Jun. 13, 2024

(54) DISPLAY DEVICE

(71) Applicant: Japan Display Inc., Tokyo (JP)

(72) Inventors: Koichi OKUDA, Tokyo (JP); Shinichi KOMURA, Tokyo (JP); Hiroaki KIJIMA, Tokyo (JP); Jin HIROSAWA, Tokyo (JP); Yasuhiro TAKAHASHI, Tokyo (JP)

(21) Appl. No.: 18/537,215

(22) Filed: Dec. 12, 2023

(30) Foreign Application Priority Data
Dec. 13, 2022 (JP) 2022-198433

(51) Int. Cl. F21V 8/00

(52) U.S. Cl. CPC G02B 6/0023; G02B 6/0045; G02B 6/0066

(57) ABSTRACT

A display device includes a display panel, and a lighting device configured to illuminate the display panel. The lighting device includes a light-guiding plate, a light-emitting element configured to emit a red laser beam toward a side surface of the light-guiding plate, and a phase difference plate placed between the side surface of the light-guiding plate and the light-emitting element.

### CROSS-REFERENCE TO RELATED APPLICATION

This application claims the benefit of priority from Japanese Patent Application No. 2022-198433 filed on Dec. 13, 2022, the entire contents of which are incorporated herein by reference.

### BACKGROUND

### 1. Technical Field

The present disclosure relates to a display device.

### 2. Description of the Related Art

Japanese Patent Application Laid-open Publication No. 2022-002205 (JP-A-2022-002205) discloses a display device including a liquid crystal display panel and a lighting device that illuminates the liquid crystal display panel. The lighting device is what is called a backlight and is placed on the rear surface side of the liquid crystal display panel. The lighting device includes a light-guiding plate and a light source. The light source is positioned so as to face a side surface of the light-guiding plate and emits light toward the side surface of the light-guiding plate.

A plurality of light-emitting elements that emit laser beams in colors different from each other may be applied to a light source (light-emitting element) that emits light toward a side surface of a light-guiding plate, as in the lighting device (lighting device) included in the display device in JP-A-2022-002205. In this case, the laser beams in colors different from each other interfere in the light-guiding plate, and white light, for example, is emitted from the front surface of the light-guiding plate toward a liquid crystal display panel (display panel).

However, when the difference in diffusion angles of rays of light emitted from the respective light-emitting elements is relatively large in plan view of the light-guiding plate, the rays of light emitted from the light-emitting elements may not sufficiently interfere in the light-guiding plate, resulting in a relatively large color difference of the light emitted from the light-guiding plate. When the color difference of the light emitted from the light-guiding plate and entering the display panel is relatively large, a desired image may not be displayed on the display panel.

It is an object of the present disclosure to ensure uniformity of color of light emitted from a lighting device in a display device.

### SUMMARY

A display device according to the present disclosure includes a display panel, and a lighting device configured to illuminate the display panel. The lighting device includes a light-guiding plate, a light-emitting element configured to emit a red laser beam toward a side surface of the light-guiding plate, and a phase difference plate placed between the side surface of the light-guiding plate and the light-emitting element.

### BRIEF DESCRIPTION OF THE DRAWINGS

FIG. 1 is a perspective view of a display device according to an embodiment of the present disclosure;

FIG. 2 is a sectional view of the display device;

FIG. 3 is a view illustrating a circuit configuration of a display panel;

FIG. 4 is a sectional view of the display panel;

FIG. 5 is a plan view of a lighting device;

FIG. 6 is a view illustrating a first light-emitting element and a red laser beam emitted by the first light-emitting element;

FIG. 7 is a view illustrating a second light-emitting element and a third light-emitting element, as well as a green laser beam emitted by the second light-emitting element and a blue laser beam emitted by the third light-emitting element;

FIG. 8 is a view illustrating the red laser beam in side view of a light-guiding plate;

FIG. 9 is a view illustrating the green laser beam and the blue laser beam in side view of the light-guiding plate; and

FIG. 10 is a sectional view of a lighting device according to a modification of the present embodiment.

### DETAILED DESCRIPTION

Embodiments of the present disclosure will be described below with reference to the drawings. The present disclosure is not limited by what is described in the following embodiments. Components described below include those that can be easily assumed by a person skilled in the art and those that are substantially the same. Furthermore, the components described below can be combined as appropriate.

What is disclosed herein is merely an example, and any appropriate modification that would be easily conceived of by a person skilled in the art, while maintaining the purport of the present disclosure, is naturally included in the scope of the present disclosure. The drawings may schematically illustrate the width, thickness, shape, and the like of each part compared to the actual mode for the sake of clarity of explanation, but this is merely an example and does not limit the interpretation of the present disclosure. In the present specification and the drawings, elements similar to those described previously with respect to the drawings already mentioned are given the same reference signs and the detailed description thereof may be omitted as appropriate.

The X and Y directions illustrated in the drawings are orthogonal to each other and parallel to a main surface of a substrate included in a display device 1. The +X and −X sides in the X direction and the +Y and −Y sides in the Y direction correspond to the sides of the display device 1. The Z direction is orthogonal to the X and Y directions and corresponds to the thickness direction of the display device 1. The +Z side in the Z direction corresponds to the front surface side where an image is displayed in the display device 1, and the −Z side in the Z direction corresponds to the rear surface side of the display device 1. The X, Y, and Z directions are examples, and the present disclosure is not limited to these directions.

In the present specification, “plan view” refers to viewing the display device 1 from the +Z side to the −Z side along the Z direction. “Side view” refers to viewing the display device 1 along a direction orthogonal to the Z direction (i.e., direction parallel to the X and Y directions).

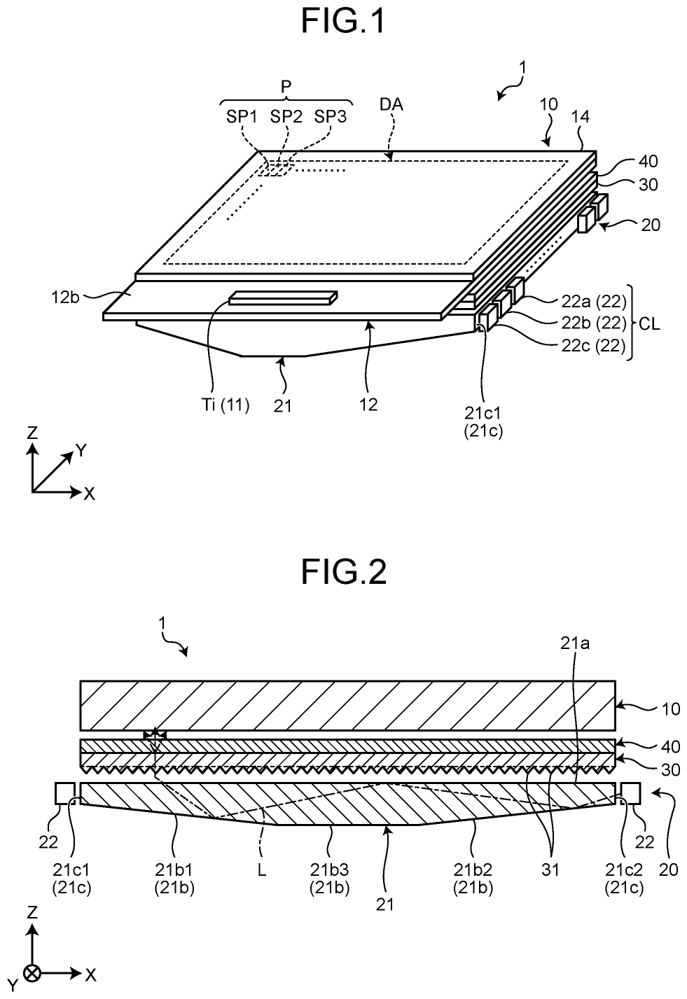

FIG. 1 is a plan view of the display device 1 according to an embodiment of the present disclosure. FIG. 2 is a sectional view of the display device 1. The display device 1 displays images on the basis of image signals output from an external device (not illustrated) that is electrically coupled through a flexible wiring board (not illustrated).

The display device 1 is used in a display system that changes displays, for example, by user movement. The display system is, for example, a virtual reality (VR) system that displays images indicating three-dimensional objects in a virtual space, and the like, and that changes the display according to the user's head orientation, or the like, to create a sense of virtual reality for the user. Examples of images include, but are not limited to, computer graphic images and 360-degree live-action images.

The display device 1 includes a display panel 10, a lighting device 20, a prism sheet 30, and a diffusion sheet 40. The lighting device 20, the prism sheet 30, and the diffusion sheet 40, and the display panel 10 are aligned in this order along the Z direction from the −Z side to the +Z side.

The display panel 10 is a transmissive liquid crystal display. The display panel 10 may be, for example, an organic electroluminescent (EL) display and an inorganic EL display. As illustrated in FIG. 1, the display panel 10 has, on the front surface thereof, a display region DA where images are displayed. The display panel 10 includes a plurality of pixels P aligned in a matrix (row-column configuration) along the X and Y directions in the display region DA.

The pixels P each have a first sub-pixel SP1, a second sub-pixel SP2, and a third sub-pixel SP3. The first sub-pixel SP1 is a red sub-pixel. The second sub-pixel SP2 is a green sub-pixel. The third sub-pixel SP3 is a blue sub-pixel. The first sub-pixel SP1, the second sub-pixel SP2 and the third sub-pixel SP3 are aligned in this order along the X direction. The array of the first sub-pixel SP1, the second sub-pixel SP2 and the third sub-pixel SP3 is what is called a stripe array. Hereinafter, when the first sub-pixel SP1, the second sub-pixel SP2, and the third sub-pixel SP3 are described without distinction, they may simply be described as a “sub-pixel SP”. Not to mention, the array of sub-pixels SP is not limited to a stripe array, and the colors of sub-pixels SP are not limited to the aforementioned colors.

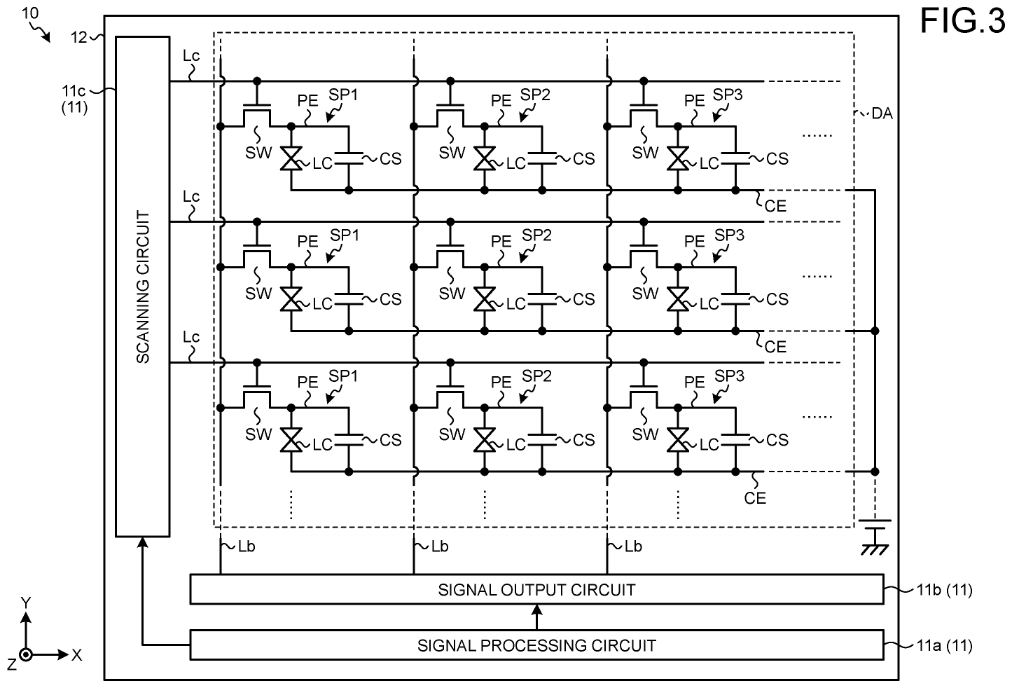

FIG. 3 is a view illustrating a circuit configuration of the display panel 10. The display panel 10 includes a drive circuit 11, as well as a switching element SW, a sub-pixel electrode PE, a common electrode CE, a liquid crystal capacitance LC, and a holding capacitance CS that are included in each of a plurality of the sub-pixels SP.

The drive circuit 11 drives the display panel 10. The drive circuit 11 includes a signal processing circuit 11a, a signal output circuit 11b, and a scanning circuit 11c.

The signal processing circuit 11a outputs sub-pixel signals indicating gradations of the sub-pixels SP to the signal output circuit 11b on the basis of image signals transmitted from the external device. The signal processing circuit 11a outputs clock signals to the signal output circuit 11b and the scanning circuit 11c to synchronize the operation of the signal output circuit 11b with that of the scanning circuit 11c.

The signal output circuit 11b outputs the sub-pixel signals to the sub-pixels SP. The signal output circuit 11b and the sub-pixels SP are electrically coupled through a plurality of signal lines Lb extending along the Y direction.

The scanning circuit 11c scans the sub-pixels SP in synchronization with the output of the sub-pixel signals by the signal output circuit 11b. The scanning circuit 11c and the sub-pixels SP are electrically coupled through a plurality of scanning lines Lc extending along the X direction.

A region demarcated by two signal lines Lb adjacent to each other in the X direction and two scanning lines Lc adjacent to each other in the Y direction in plan view corresponds to a sub-pixel SP.

The switching element SW includes a thin-film transistor (TFT), for example. In the switching element SW, a source electrode is electrically coupled to the signal line Lb, and a gate electrode is electrically coupled to the scanning line Lc.

The sub-pixel electrode PE is coupled to a drain electrode of the switching element SW. A plurality of the common electrodes CE are arranged corresponding to the scanning lines Lc. The sub-pixel electrode PE and the common electrode CE are translucent.

The liquid crystal capacitance LC is a capacitive component of a liquid crystal material in a liquid crystal layer 13, which will be described below, between the sub-pixel electrode PE and the common electrode CE. The holding capacitance CS is placed between an electrode with the same potential as the common electrode CE and an electrode with the same potential as the sub-pixel electrode PE.

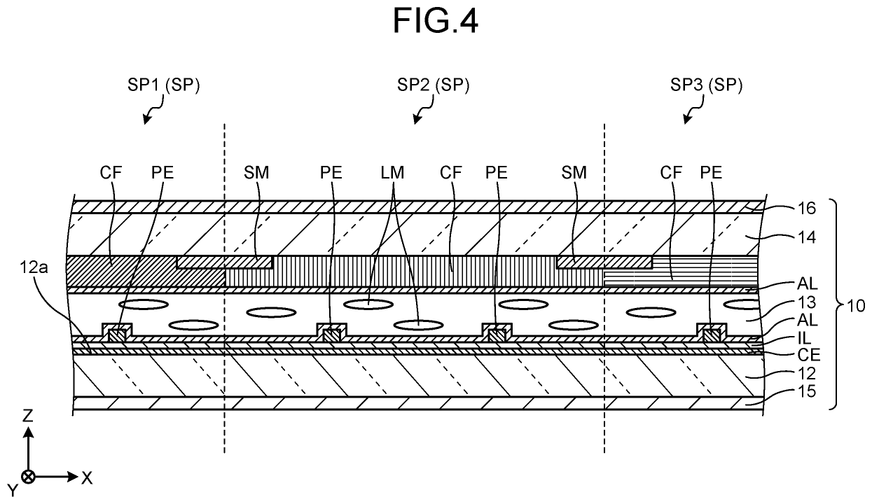

FIG. 4 is a sectional view of the display panel 10. The sub-pixel SP further includes a first substrate 12, the liquid crystal layer 13, and a second substrate 14. The first substrate 12, the liquid crystal layer 13, and the second substrate 14 are all translucent and are aligned in this order along the Z direction from the −Z side to the +Z side. The first substrate 12 and the second substrate 14 are rectangular in plan view.

The common electrode CE is placed on a main surface 12a on the +Z-side of the first substrate 12. An insulating layer IL is placed on the front surface of the common electrode CE, and the sub-pixel electrode PE and an orientation film AL are further placed.

The sub-pixel electrode PE is placed between the insulating layer IL and the orientation film AL. In this manner, the common electrode CE is placed on, and the sub-pixel electrode PE is placed above the first substrate 12. In other words, the display panel 10 is a horizontal electric field type liquid crystal display.

The second substrate 14 is located on the front surface side of the first substrate 12. A color filter CF and a light-shielding film SM are placed on, and an orientation film AL is placed under the rear surface of the second substrate 14. The light-shielding film SM and the color filter CF are placed between the second substrate 14 and the orientation film AL.

The color filter CF is rectangular in plan view and one color filter CF is placed for one sub-pixel SP. The color filter CF is translucent, and the peak of the spectrum of light to be transmitted is predetermined. The peak of the spectrum corresponds to the color of the color filter CF. The color of the color filter CF is the same as that of the sub-pixel SP. In other words, the red first sub-pixel SP1 has a red color filter CF, the green second sub-pixel SP2 has a green color filter CF, and the blue third sub-pixel SP3 has a blue color filter CF.

The light-shielding film SM is lightproof and overlaps in plan view the boundaries of the sub-pixels SP that are adjacent to each other in the X and Y directions. That is, the light-shielding film SM overlaps the signal line Lb and the scanning line Lc in plan view. In FIG. 4, the signal line Lb and the scanning line Lc are omitted. The signal lines Lb and the scanning lines Lc are placed on the main surface 12a of the first substrate 12.

The liquid crystal layer 13 includes a plurality of liquid crystal molecules LM. The liquid crystal layer 13 is present between the first substrate 12 and the second substrate 14 and overlaps the display region DA in plan view. Specifically, the liquid crystal layer 13 is present between two orientation films AL facing each other. The orientation of the liquid crystal molecules LM is regulated by the two orientation films AL facing each other.

As illustrated in FIG. 4, the display panel 10 further includes a first polarizing plate 15 placed on the rear surface of the first substrate 12 and a second polarizing plate 16 placed on the front surface of the second substrate 14.

The first polarizing plate 15 has a transmission axis orthogonal to the Z direction. The front surface of the first polarizing plate 15 corresponds to the front surface of the display panel 10. The second polarizing plate 16 has a transmission axis orthogonal to the transmission axis of the first polarizing plate 15 and the Z direction.

As illustrated in FIG. 1, the first substrate 12 has an exposed portion 12b that is exposed from the second substrate 14 in plan view. The exposed portion 12b is on the −Y side of the second substrate 14 in plan view. An IC chip Ti including the drive circuit 11 is placed on the front surface of the exposed portion 12b. The front surface of the exposed portion 12b is part of the main surface 12a of the first substrate 12. The first polarizing plate 15, the second polarizing plate 16, and the liquid crystal layer 13 are omitted in FIG. 1.

As illustrated in FIG. 2, the lighting device 20 is placed on the rear surface side of the display panel 10. The lighting device 20 illuminates the display panel 10. The lighting device 20 emits light (hereinafter described as emitted light) toward the display panel 10. The details of the lighting device 20 will be described below. The emitted light enters the prism sheet 30.

The prism sheet 30 refracts the emitted light of the lighting device 20 in a direction in which the optical axis of the emitted light is along the Z direction. The prism sheet 30 has a plurality of prisms 31 that are triangular in section, that face the lighting device 20, and that extend along the Y direction. The prisms 31 may be placed in a state of facing the diffusion sheet 40. The emitted light from the prism sheet 30 enters the diffusion sheet 40.

The diffusion sheet 40 diffuses the emitted light. The emitted light from the diffusion sheet 40 enters the display panel 10. The viewing angle of the display panel 10 can be increased by diffusing the emitted light with the diffusion sheet 40.

The emitted light transmits through the display panel 10. In the display panel 10, the drive circuit 11 outputs sub-pixel signals to the sub-pixels SP on the basis of image signals, thereby generating an electric field in the liquid crystal layer 13 and changing the orientation of the liquid crystal molecules LM. Thus, the emitted light transmitted through the display panel 10 is modulated, to display an image on the display region DA.

The details of the lighting device 20 will be described next.

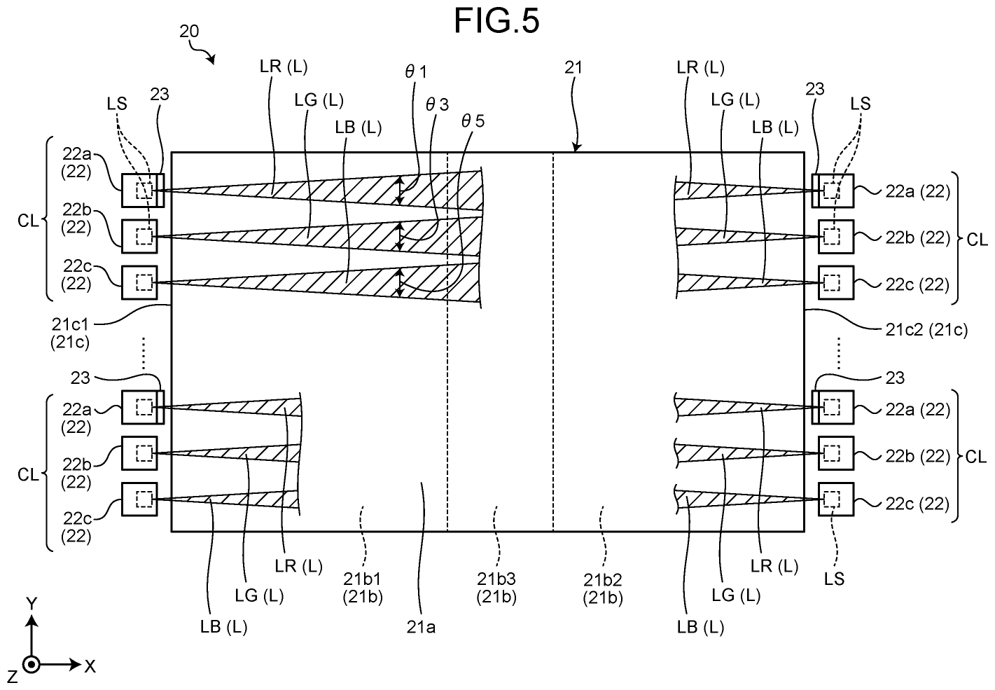

FIG. 5 is a plan view of the lighting device 20. As illustrated in FIGS. 1, 2, and 5, the lighting device 20 includes a light-guiding plate 21, a plurality of first light-emitting elements 22a, a plurality of second light-emitting elements 22b, and a plurality of third light-emitting elements 22c. Hereinafter, when the first light-emitting element 22a, the second light-emitting element 22b, and the third light-emitting element 22c are described without distinction, they may simply be referred to as a “light-emitting element 22”.

As illustrated in FIGS. 2 and 5, the light-guiding plate 21 is rectangular in plan view. The light-guiding plate 21 has plane symmetry with respect to a plane passing through the center of the light-guiding plate 21 and orthogonal to the X direction.

A front surface 21a of the light-guiding plate 21 is a plane orthogonal to the Z direction. The emitted light is emitted from the front surface 21a of the light-guiding plate 21 toward the display panel 10. A rear surface 21b of the light-guiding plate 21 has a first inclined surface 21b1, a second inclined surface 21b2, and a coupling surface 21b3.

The first inclined surface 21b1 is on the −X side of the rear surface 21b and is a plane having an inclination toward the −Z side along the Z direction as the inclination tends toward the +X side along the X direction. The second inclined surface 21b2 is on the +X side of the rear surface 21b and is a plane having an inclination toward the −Z side along the Z direction as the inclination tends toward the −X side along the X direction.

The coupling surface 21b3 couples the first inclined surface 21b1 and the second inclined surface 21b2 at the central portion of the rear surface 21b in the X direction. In other words, the coupling surface 21b3 is on the +X side of the first inclined surface 21b1 and is continuous with the first inclined surface 21b1. The coupling surface 21b3 is on the −X side of the second inclined surface 21b2 and is continuous with the second inclined surface 21b2. The coupling surface 21b3 is a plane parallel to the front surface 21a.

A first side surface 21c1 on the −X side of the light-guiding plate 21 is a plane orthogonal to the X direction and couples the first inclined surface 21b1 and the front surface 21a. A second side surface 21c2 on the +X side of the light-guiding plate 21 is a plane orthogonal to the X direction and couples the second inclined surface 21b2 and the front surface 21a. Hereinafter, when the first side surface 21cl and the second side surface 21c2 are described without distinction, they may simply be described as a “side surface 21c”.

A plurality of the light-emitting elements 22 emit light toward the side surface 21c. Specifically, as illustrated in FIG. 5, the first light-emitting elements 22a emit red laser beams LR. The second light-emitting elements 22b emit green laser beams LG. The third light-emitting elements 22c emit blue laser beams LB. Not to mention, the colors of laser beams L of the second light-emitting elements 22b and the third light-emitting elements 22c are not limited to the aforementioned colors (green and blue). Not to mention, the number of types of the light-emitting elements 22 is not limited to three. For example, the lighting device 20 may further include a fourth light-emitting element that emits a laser beam in a color different from red, green, and blue.

Hereinafter, when the red laser beam LR, the green laser beam LG, and the blue laser beam LB are described without distinction, they may simply be described as a “laser beam L”. FIG. 5 illustrates the laser beams L in plan view of the light-guiding plate 21. The optical axis of the laser beam L is along the X direction in plan view.

The light-emitting elements 22 are arranged in a state of facing the side surfaces 21c of the light-guiding plate 21. The light-emitting elements 22 are arranged along the Y direction. Specifically, one first light-emitting element 22a, one second light-emitting element 22b, and one third light-emitting element 22c aligned from the +Y side to the −Y side along the Y direction constitute one set of light-emitting elements CL, and a plurality of sets of the light-emitting elements CL are aligned along the Y direction.

As illustrated by the dash-dotted line arrows in FIG. 2, the laser beam L emitted from the light-emitting element 22 facing the second side surface 21c2 enters the light-guiding plate 21 from the second side surface 21c2, repeats total reflection at the rear surface 21b and the front surface 21a, and then is emitted from the front surface 21a. On the contrary, the laser beam L (not illustrated) emitted from the light-emitting element 22 facing the first side surface 21cl enters the light-guiding plate 21 from the first side surface 21c1, repeats total reflection at the rear surface 21b and the front surface 21a, and then is emitted from the front surface 21a.

In other words, the inclination angles of the first inclined surface 21b1 and the second inclined surface 21b2 are defined as the angles at which the laser beam L is emitted from the front surface 21a. The laser beams L from the light-emitting elements 22 interfere with each other by repeating total reflection in the light-guiding plate 21, resulting in the color of the emitted light being white.

The dash-dotted line arrows in FIG. 2 indicate the path of the laser beam L emitted from the light-emitting element 22, which, after being reflected in the light-guiding plate 21, is emitted from the light-guiding plate 21, refracted by the prism sheet 30, diffused by the diffusion sheet 40, and enters the display panel 10. Not to mention, the path of the laser beam L is not limited to that illustrated by the dash-dotted line arrows in FIG. 2.

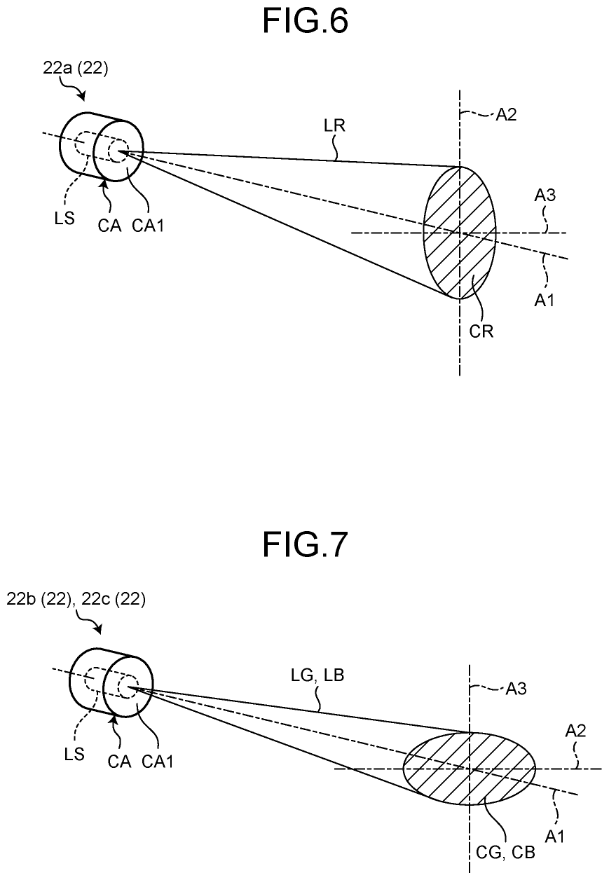

FIG. 6 is a view illustrating the first light-emitting element 22a and the red laser beam LR emitted by the first light-emitting element 22a. A phase difference plate 23 to be described below is not placed on the first light-emitting element 22a illustrated in FIG. 6.

FIG. 7 is a view illustrating the second light-emitting element 22b and the third light-emitting element 22c, as well as the green laser beam LG emitted by the second light-emitting element 22b and the blue laser beam LB emitted by the third light-emitting element 22c.

As illustrated in FIGS. 6 and 7, the light-emitting element 22 includes a light source LS that emits the laser beam L and a casing CA that houses therein the light source LS. The casing CA is hollow and columnar, and has an end surface CA1 from which the laser beam L is emitted. The end surface CA1 faces the side surface 21c of the light-guiding plate 21.

The light source LS emits the laser beam L. The light source LS is, for example, a laser diode. The light source LS of the first light-emitting element 22a emits the red laser beam LR, the light source LS of the second light-emitting element 22b emits the green laser beam LG, and the light source LS of the third light-emitting element 22c emits the blue laser beam LB.

The polarization direction of the laser beam L is along the Y direction. As described above, an optical axis A1 of the laser beam L is along the X direction in plan view. The sectional shape of the laser beam L when cut in a plane orthogonal to the optical axis A1 of the laser beam L (shapes illustrated by hatching in FIGS. 6 and 7) is an ellipse.

In a sectional shape CR of the red laser beam LR of the first light-emitting element 22a illustrated in FIG. 6, a major axis A2 is orthogonal to the Y direction (polarization direction of the laser beam L) and a minor axis A3 is along the Y direction.

On the contrary, in a sectional shape CG of the green laser beam LG of the second light-emitting element 22b illustrated in FIG. 7, the major axis A2 is along the Y direction and the minor axis A3 is orthogonal to the Y direction. Similarly to the sectional shape CG of the green laser beam LG, in a sectional shape CB of the blue laser beam LB of the third light-emitting element 22c, the major axis A2 is along the Y direction and the minor axis A3 is orthogonal to the Y direction.

In this manner, the relation between the major axis A2 and the minor axis A3 of the red laser beam LR of the first light-emitting element 22a and the relation between the major axis A2 and the minor axis A3 of the laser beams L of the second light-emitting element 22b and the third light-emitting element 22c are inverse. Specifically, the minor axis A3 in the sectional shape CR of the red laser beam LR of the first light-emitting element 22a and the long axis A2 in the sectional shapes CG, CB of the laser beams L of the second light-emitting element 22b and the third light-emitting element 22c are both along the Y direction. As a result, the spread of the red laser beam LR of the first light-emitting element 22a is narrower than the spread of the laser beams L of the second light-emitting element 22b and the third light-emitting element 22c (that is, the spread in the Y direction) in plan view of the light-guiding plate 21.

Therefore, in this case, the red laser beam LR of the first light-emitting element 22a is reflected in the light-guiding plate 21 in an undiffused state relative to the laser beams L of the second light-emitting element 22b and the third light-emitting element 22c. Thus, the laser beams L of the light-emitting elements 22 do not sufficiently interfere with each other in the light-guiding plate 21, resulting in a relatively large color difference of the emitted light, and a desired image may not be displayed in the display region DA.

Consequently, as illustrated in FIG. 5, the lighting device 20 further includes the phase difference plate 23 placed between the side surface 21c of the light-guiding plate 21 and the first light-emitting element 22a. The phase difference plate 23 is placed on the end surface CA1 of the first light-emitting element 22a. The phase difference plate 23 is a half-wave plate. The phase difference plate 23 is not placed between the side surface 21c of the light-guiding plate 21 and the second light-emitting element 22b or the third light-emitting element 22c. The red laser beam LR illustrated in FIG. 5 is in a state of having transmitted through the phase difference plate 23.

The phase difference plate 23 rotates the polarization direction of the red laser beam LR of the first light-emitting element 22a by 90° around the optical axis A1. As a result, in the sectional shape of the red laser beam LR of the first light-emitting element 22a transmitted through the phase difference plate 23, the major axis A2 of the elliptical shape is along the Y direction and the minor axis A3 of the elliptical shape is orthogonal to the Y direction, similarly to the laser beams L of the second light-emitting element 22b and the third light-emitting element 22c.

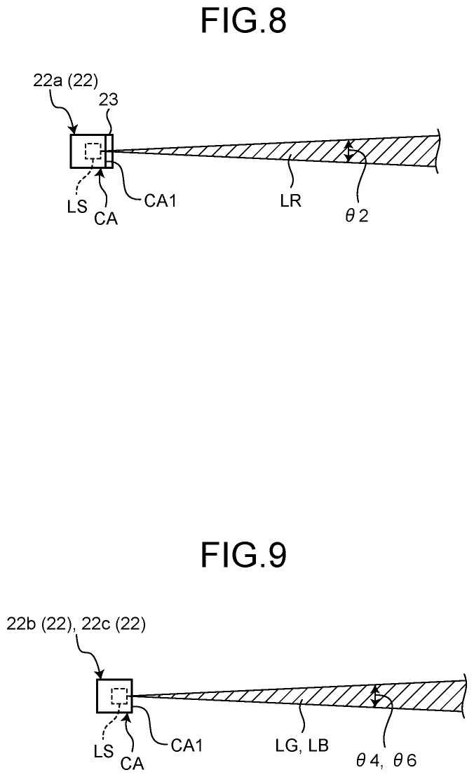

FIG. 8 is a view illustrating the red laser beam LR in side view of the light-guiding plate 21. FIG. 8 specifically illustrates the red laser beam LR when the light-guiding plate 21 is viewed along the Y direction. The phase difference plate 23 is placed on the first light-emitting element 22a illustrated in FIG. 8.

As described above, the phase difference plate 23 is placed on the end surface CA1 of the first light-emitting element 22a, and the polarization direction of the red laser beam LR of the first light-emitting element 22a rotates 90° around the optical axis A1. Thus, a first diffusion angle θ1 (see FIG. 5) of the red laser beam LR in plan view of the light-guiding plate 21 is larger than a second diffusion angle θ2 (see FIG. 8) of the red laser beam LR in side view of the light-guiding plate 21.

FIG. 9 is a view illustrating the green laser beam LG and the blue laser beam LB in side view of the light-guiding plate 21. FIG. 9 specifically illustrates the green laser beam LG and the blue laser beam LB when the light-guiding plate 21 is viewed along the Y direction.

As described above, in the sectional shapes CG, CB of the green laser beam LG and the blue laser beam LB, the major axis A2 is along the Y direction and the minor axis A3 is orthogonal to the Y direction. Thus, a third diffusion angle θ3 (see FIG. 5) of the green laser beam LG in plan view of the light-guiding plate 21 is larger than a fourth diffusion angle θ4 (see FIG. 9) of the green laser beam LG in side view of the light-guiding plate 21. A fifth diffusion angle θ5 (see FIG. 5) of the blue laser beam LB in plan view of the light-guiding plate 21 is larger than a sixth diffusion angle θ6 (see FIG. 9) of the blue laser beam LB in side view of the light-guiding plate 21.

Consequently, the difference in the spread of the respective laser beams L of the first light-emitting element 22a, the second light-emitting element 22b, and the third light-emitting element 22c is relatively small in plan view of the light-guiding plate 21. Consequently, the laser beams L of the light-emitting elements 22 sufficiently interfere with each other in the light-guiding plate 21, to ensure uniformity of color of the emitted light. With this operation, a desired image can be displayed in the display region DA.

In FIGS. 5 and 9, the green laser beam LG and the blue laser beam LB are illustrated by the same line, and the spread of the laser beams L illustrated in the drawings is the same. However, the spread of the green laser beam LG and that of the blue laser beam LB may differ from each other. In other words, the fourth diffusion angle θ4 of the green laser beam LG and the sixth diffusion angle θ6 of the blue laser beam LB illustrated in FIG. 9 may differ from each other.

Although preferred embodiments of the present disclosure have been described above, the present disclosure is not limited to such embodiments. What is disclosed in the embodiments is merely an example, and various modifications can be made without departing from the intent of the present disclosure. Any appropriate modification made to the extent not departing from the intent of the present disclosure naturally belongs to the technical scope of the present disclosure.

For example, the phase difference plate 23 may be placed on the side surface 21c of the light-guiding plate 21 so as to face the first light-emitting element 22a.

A set of light-emitting elements CL may be formed integrally. In this case, specifically, the light source LS of the red laser beam LR, the light source LS of the green laser beam LG, and the light source LS of the blue laser beam LB are housed in one casing CA. In this case, the phase difference plate 23 is placed on the path of the red laser beam LR and out of the path of the green laser beam LG and the path of the blue laser beam LB.

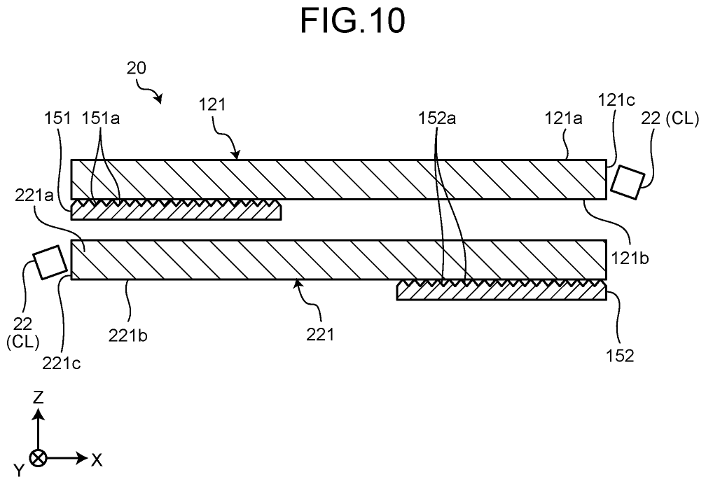

FIG. 10 is a sectional view of the lighting device 20 according to a modification of the present embodiment. The lighting device 20 of the present modification has a first light-guiding plate 121 and a second light-guiding plate 221. The first light-guiding plate 121 and the second light-guiding plate 221 have the same shape, for example, a rectangular parallelepiped. The second light-guiding plate 221 is placed on a rear surface 121b side of the first light-guiding plate 121.

The rear surface 121b of the first light-guiding plate 121 is a plane parallel to a front surface 121a. A second prism sheet 151 is placed in a section on the −X side of the rear surface 121b of the first light-guiding plate 121 with respect to the central portion in the X direction. The second prism sheet 151 has a plurality of prisms 151a that are triangular in section, that face the first light-guiding plate 121, and that extend along the Y direction.

A plurality of sets of the light-emitting elements CL are present at positions facing a side surface 121c on the +X side of the first light-guiding plate 121. The end surface CA1 of the light-emitting element 22 is inclined to the side surface 121c on the +X side of the first light-guiding plate 121. The laser beam L emitted from the light-emitting element 22 enters the first light-guiding plate 121 from the side surface 121c on the +X side of the first light-guiding plate 121, and repeats total reflection at the front surface 121a and the rear surface 121b of the first light-guiding plate 121. The laser beam L is then reflected by the second prism sheet 151, thereby being emitted from the front surface 121a of the first light-guiding plate 121 toward the display panel 10.

On the contrary, a rear surface 221b of the second light-guiding plate 221 is a plane parallel to a front surface 221a. A third prism sheet 152 is placed in a section on the +X side of the rear surface 221b of the second light-guiding plate 221 with respect to the central portion in the X direction. The third prism sheet 152 has a plurality of prisms 152a that are triangular in section, that face the second light-guiding plate 221, and that extend along the Y direction.

A plurality of sets of the light-emitting elements CL are present at positions facing a side surface 221c on the −X side of the second light-guiding plate 221. The end surface CA1 of the light-emitting element 22 is inclined to the side surface 221c on the −X side of the second light-guiding plate 221. The laser beam L emitted from the light-emitting element 22 enters the second light-guiding plate 221 from the side surface 221c on the −X side of the second light-guiding plate 221, and repeats total reflection at the front surface 221a and the rear surface 221b of the second light-guiding plate 221. The laser beam L is then reflected by the third prism sheet 152, thereby being emitted from the front surface 221a of the second light-guiding plate 221 through the first light-guiding plate 121 toward the display panel 10.

The laser beams L from the light-emitting elements 22 interfere with each other by repeating total reflection in the first light-guiding plate 121 and the second light-guiding plate 221, resulting in the color of the emitted light being white.

It is understood that any other effects brought about by the modes described in the embodiments that are obvious from the description of the present specification or that would be conceived of by a person skilled in the art are naturally brought about by the present disclosure. Further, the first light-emitting elements 22a corresponds to “a light-emitting element”. The second light-emitting element 22b and the third light-emitting element 22c correspond to “a second light-emitting element”, respectively. The first diffusion angle θ1 corresponds to “a diffusion angle of the red laser beam in plan view of the light-guiding plate”. The second diffusion angle θ2 corresponds to “a diffusion angle of the red laser beam in side view of the light-guiding plate”. The third diffusion angle θ3 and the fifth diffusion angle θ5 correspond to “a diffusion angle of the laser beam in a color different from red in plan view of the light-guiding plate”, respectively. The fourth diffusion angle θ4 and the sixth diffusion angle θ6 correspond to “a diffusion angle of the laser beam in a color different from red in side view of the light-guiding plate”, respectively.

What is claimed is:

1. A display device comprising:
a display panel; and
a lighting device configured to illuminate the display panel, wherein
the lighting device comprises:
a light-guiding plate;
a light-emitting element configured to emit a red laser beam toward a side surface of the light-guiding plate; and
a phase difference plate placed between the side surface of the light-guiding plate and the light-emitting element.

2. The display device according to claim 1, wherein the phase difference plate is a half-wave plate.

3. The display device according to claim 1, wherein the phase difference plate is placed on the light-emitting element.

4. The display device according to claim 1, wherein a diffusion angle of the red laser beam in plan view of the light-guiding plate is larger than a diffusion angle of the red laser beam in side view of the light-guiding plate.

5. The display device according to claim 4, wherein
the lighting device further comprises a second light-emitting element configured to emit a laser beam in a color different from red toward the side surface of the light-guiding plate, and
a diffusion angle of the laser beam in a color different from red in plan view of the light-guiding plate is larger than a diffusion angle of the laser beam in a color different from red in side view of the light-guiding plate.
